(19) United States
(12) Patent Application Publication
(10) Pub. No.: US 2023/0381838 A1
(43) Pub. Date: Nov. 30, 2023

(54) MIST COLLECTING SYSTEM FOR MULTIPLE PROCESSING CHAMBERS

(71) Applicant: FUJI CORPORATION, Chiryu (JP)

(72) Inventor: Noritaka AKATSU, Tomakomai-shi (JP)

(73) Assignee: FUJI CORPORATION, Chiryu (JP)

(21) Appl. No.: 18/308,839

(22) Filed: Apr. 28, 2023

(30) Foreign Application Priority Data
May 24, 2022 (JP) 2022-084209

(51) Int. Cl. B08B 15/02; B08B 15/00

(52) U.S. Cl. CPC B08B 15/023; B08B 15/002

(57) ABSTRACT

To provide a mist collecting system for multiple processing chambers that appropriately performs mist collection in multiple processing chambers by a single mist collector. A mist collecting system for multiple processing chambers including a mist collector configured to collect mist generated in a processing chamber, a duct that is branched and configured to connect the mist collector to multiple processing chambers, multiple electric duct shutters that are provided corresponding to the multiple processing chambers and are piped to branched portions of the duct, and a control device configured to control the mist collector and opening/closing of each of the multiple duct shutters.

### TECHNICAL FIELD

The present disclosure relates to a mist collecting system for multiple processing chambers that performs mist collection, by a single mist collector, in a machine tool or a processing machine line having multiple processing chambers.

### BACKGROUND ART

In a machine tool, coolant is used for a purpose of flushing chips generated during processing or for a purpose of cooling a processing section, so that the coolant is scattered in a processing chamber in which cutting processing with a lathe or the like is performed. For example, Patent Literature 1 discloses a mist collecting system for preventing chips or mist generated during the processing (such as soot and splashes thereof generated by supply of coolant or lubricant) from entering a non-processing area. Specifically, a mist collector that collects mist or the like in a processing chamber is provided in a machine tool, a suction duct is connected between the mist collector and the processing chamber, and a supply duct is connected to an outside area of the processing chamber in the machine tool.

In the mist collecting system of the conventional art, the mist or the like contained in air sent from the suction duct is removed and cleaned air is discharged, and in the supply duct, the air discharged from the mist collector is supplied to the outside area of the processing chamber. Therefore, it is possible to prevent chips or mist in the processing chamber from entering the outside area of the processing chamber.

### PATENT LITERATURE

Patent Literature 1: Japanese Utility Model Registration No. 3228799

### BRIEF SUMMARY

### Technical Problem

However, the mist collecting system of the conventional art is configured with a purpose of mist collection for one processing chamber, and a configuration in which processing chambers are divided into two portions in a single machine tool such as a dual-spindle lathe is not considered. For example, in a mist collecting system in which a mist collector is prepared for each of multiple processing chambers, cost increases, and an entire size of a machine tool, a processing machine line, or the like that is a target also increases. On the other hand, in a case where multiple processing chambers are supported by a single mist collector, the mist collector continues to be driven. For that reason, scraps during processing are sucked in to cause the duct to be damaged, and coolant of a processing blow is directly sucked in to cause the mist collector to be damaged.

Accordingly, an object of the present disclosure is to provide a mist collecting system for multiple processing chambers that appropriately performs mist collection in multiple processing chambers by a single mist collector in order to solve such a problem.

### Solution to Problem

A mist collecting system for multiple processing chambers according to the present disclosure includes a mist collector configured to collect mist generated in a processing chamber, a duct that is branched and configured to connect the mist collector to multiple processing chambers, multiple electric duct shutters that are provided corresponding to the multiple processing chambers and are piped to branched portions of the duct, and a control device configured to control the mist collector and opening/closing of each of the multiple duct shutters.

### Advantageous Effects

According to the configuration, in multiple processing chambers connected to the mist collector via the branched duct, by respectively performing the opening/closing control over the multiple duct shutters, a processing chamber corresponding to a duct shutter in an opened state communicates with the mist collector, and a processing chamber corresponding to a duct shutter in a closed state is shut off from communication with the mist collector. Therefore, even in a case where there is a processing chamber in which a workpiece is under workpiece processing, only a processing chamber requiring mist collection can be brought into communication with the mist collector, so that it is possible to perform mist collection targeting multiple processing chambers by a single mist collector.

### BRIEF DESCRIPTION OF DRAWINGS

FIG. 1 is a front view showing a machine tool equipped with a mist collecting system for multiple processing chambers.

FIG. 2 is a diagram schematically showing interiors of the processing chambers of the machine tool.

FIG. 3 is a diagram showing duct shutters.

FIG. 4 is a front view of a processing machine line showing a second embodiment of the mist collecting system for multiple processing chambers.

### DESCRIPTION OF EMBODIMENTS

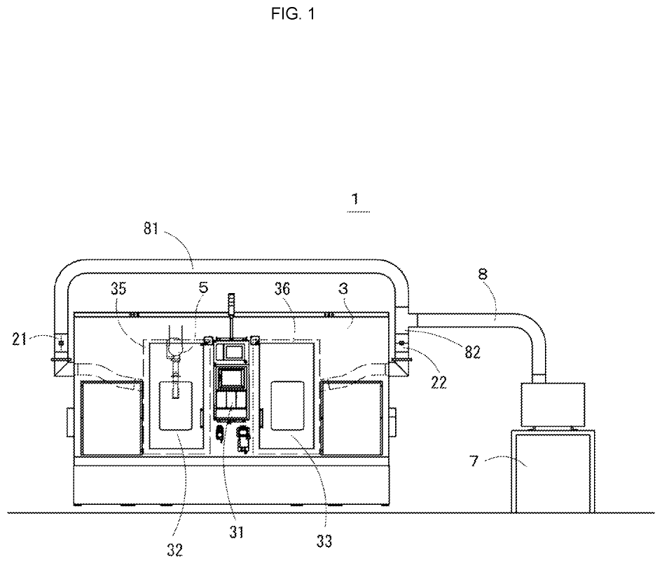

One embodiment of a mist collecting system for multiple processing chambers according to the present disclosure will be described below with reference to the drawings. FIG. 1 is a front view showing a machine tool equipped with the mist collecting system for multiple processing chambers. Machine tool 1 is entirely covered with body cover 3, operation panel 31 is disposed at the center of a front face, and opening/closing doors 32 and 33 are formed on both left and right sides of operation panel 31. Machine tool 1 is a dual-spindle lathe in which a lathe is configured symmetrically in a left-right direction in a machine, and opening/closing doors 32 and 33 are provided in front opening sections of first processing chamber 35 and second processing chamber 36.

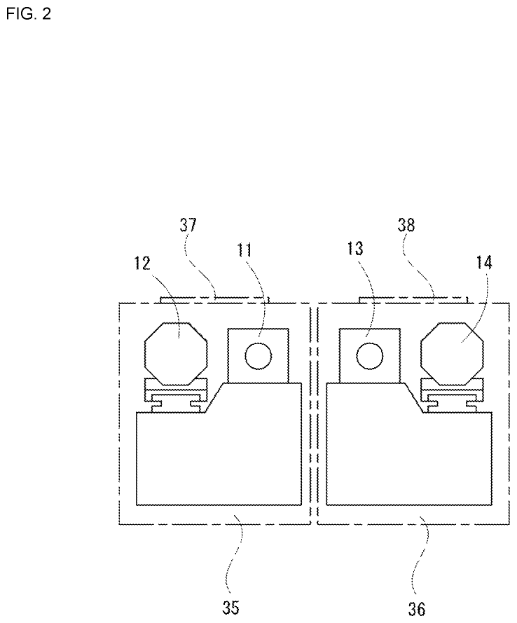

FIG. 2 is a diagram schematically showing interiors of the processing chambers of machine tool 1. First main spindle device 11 and first turret device 12 are disposed in first processing chamber 35, and second main spindle device 13 and second turret device 14 are disposed in second processing chamber 36. First and second main spindle devices 11 and 13 are provided with a main spindle chuck for holding a workpiece, and receive rotation of a spindle motor to give rotation to the held workpiece. In addition, first and second turret devices 12 and 14 are configured such that multiple tools are detachably attached to a polygonal cutter holder, the cutter holder revolves by rotation control of a servomotor, and revolving indexing of a specific tool from the multiple tools is performed.

Automatic workpiece conveyor 5 in gantry type is provided in machine tool 1, and conveyance of a workpiece is performed in process. Opening sections for conveying a workpiece in and out are formed in ceilings of first and second processing chambers 35 and 36, and slide-type opening/closing shutters 37 and 38 are provided there. Automatic-conveyance of a workpiece performed by automatic workpiece conveyor 5 is performed through the opening section in which opening/closing shutters 37 and 38 have been opened.

As shown in FIG. 1, in machine tool 1 as viewed from a front side, a workpiece stocker on which multiple workpieces before processing are mounted is disposed on a left side, and a retrieving stocker for receiving a workpiece after processing is disposed on a right side. And predetermined processing in each of first processing chamber 35 and second processing chamber 36 is performed to the workpiece conveyed by automatic workpiece conveyor 5. In machine tool 1, in a case where workpiece processing is performed, scraps or the like are generated in first and second processing chambers 35 and 36, and coolant is jetted in order to flush the scraps or cool a processing section.

In the workpiece processing performed by jetting coolant, the coolant is turned into a mist form (atomized form) by processing heat. In a case where the mist is discharged from an inside of first and second processing chambers 35 and 36 to an outside, machine tool 1 and the periphery thereof is contaminated. Therefore, mist generated in first and second processing chambers 35 and 36 is required to be collected in the respective spaces so as not to be discharged to the outside.

Therefore, in machine tool 1, mist collector 7 is used in order to collect mist generated in the processing chamber. In particular, in the present embodiment, the mist collecting system for multiple processing chambers by single mist collector 7 is configured for machine tool 1 that is a dual-spindle lathe. Mist collector 7 is a general filter-type mist collector, and is configured to pass mist sucked from first and second processing chambers 35 and 36 by a fan through multiple filters and to discharge the mist through a lower drain. Mist collector 7 is connected to a control device of machine tool 1, and drive control according to a process program is performed.

Mist collector 7 is connected to duct 8 branched for machine tool 1 in order to suck mist by the fan. In duct 8, branched first duct 81 is connected to first processing chamber 35, and branched second duct 82 is connected to second processing chamber 36. In the mist collecting system for multiple processing chambers of the present embodiment, electric first duct shutter 21 is provided in first duct 81, and electric second duct shutter 22 is likewise provided in second duct 82. Opening/closing control of first duct shutter 21 and opening/closing control of second duct shutter 22 are independently performed by the control device of machine tool 1.

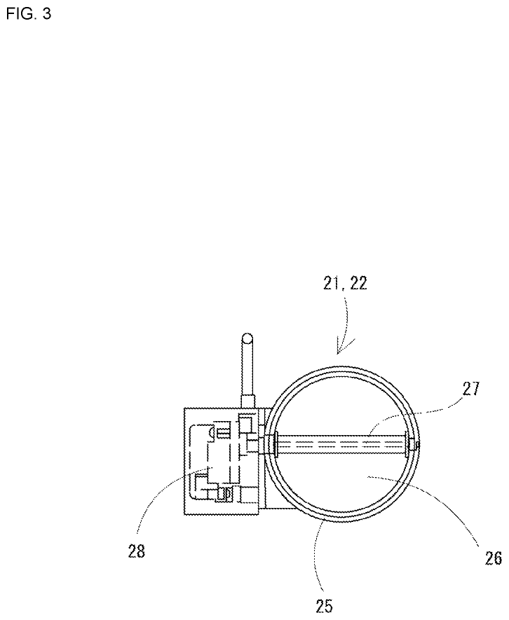

FIG. 3 is a diagram showing first duct shutter 21 and second duct shutter 22. First duct shutter 21 and second duct shutter 22 have the same structure, and circular opening/closing plate 26 is pivotally supported inside cylindrical body 25 by radially directed rotary shaft 27 passing through a center position of opening/closing plate 26. Gear motor 28 is connected to a first end of rotary shaft 27, and a spring for returning opening/closing plate 26 to an original closed state is attached to a second end of rotary shaft 27.

Subsequently, in machine tool 1, as described above, the predetermined processing in each of first processing chamber 35 and second processing chamber 36 is performed to the workpiece conveyed by an automatic workpiece conveyor. In a case where the fan of mist collector 7 is driven during the workpiece processing, mist collector 7 may directly suck in coolant of a processing blow, and may suck in even scraps to be damaged. However, since the workpiece processing in first processing chamber 35 and second processing chamber 36 is not always performed at the same timing, in a case where the driving of the fan is stopped, mist generated in one of first and second processing chambers 35 and 36 in which the processing has been completed cannot be collected, so that the mist flows to the outside of the one of first and second processing chambers 35 and 36.

Therefore, in the present embodiment, opening/closing of first duct shutter 21 is controlled in accordance with timings of processing and non-processing of a workpiece in first processing chamber 35, and opening/closing of second duct shutter 22 is likewise controlled in accordance with timings of processing and non-processing of a workpiece in second processing chamber 36. In the mist collecting system for multiple processing chambers of the present embodiment, in a case where the workpiece processing is performed in both first processing chamber 35 and second processing chamber 36, first duct shutter 21 and second duct shutter 22 are closed, and the driving of the fan in mist collector 7 is stopped.

In an example of FIG. 1, first duct shutter 21 is opened, duct 8 communicates between first processing chamber 35 and mist collector 7, and the fan rotates by the driving of mist collector 7, so that mist in first processing chamber 35 is sucked into first duct 81 and is collected. On the other hand, the processing of a workpiece is performed in second processing chamber 36 connected to the same mist collector 7 by duct 8 at that time, so that scraps or coolant are scattered. However, since second duct shutter 22 is closed and second duct 82 is shut off, scraps or coolant in second processing chamber 36 are not sucked into mist collector 7 that is driven.

Thereafter, in a case where the workpiece processing in second processing chamber 36 is completed, the jetting of coolant is stopped, second duct shutter 22 is opened, and collection of mist generated in second processing chamber 36 is performed. At this time, in a case where the workpiece processing is not started in first processing chamber 35, mist collector 7 collects mist in first processing chamber 35 and mist in second processing chamber 36 simultaneously. And in a case where the next workpiece processing is started in first processing chamber 35 and second processing chamber 36, first duct shutter 21 and second duct shutter 22 are closed at respective timings.

Therefore, in the mist collecting system for multiple processing chambers of the present embodiment, it is possible to selectively collect mist in first processing chamber 35 and mist in second processing chamber 36 by the opening/closing control of each of first duct shutter 21 and second duct shutter 22. It is possible to perform mist collection by single mist collector 7 for two processing chambers, which is efficient, and it is also possible to reduce installation space of machine tool 1.

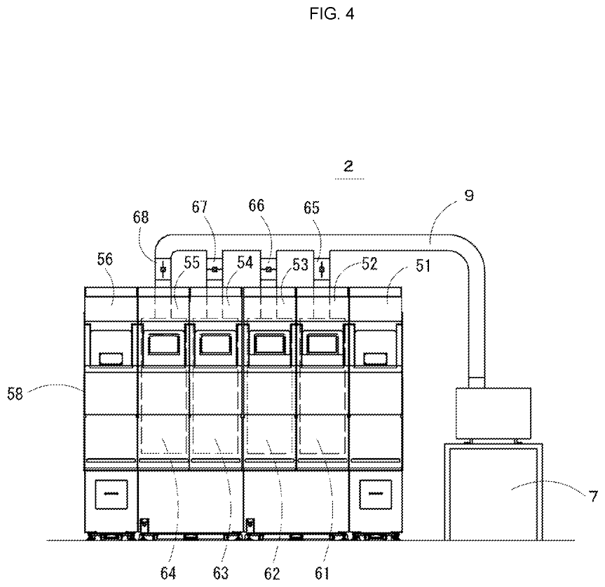

Next, FIG. 4 is a front view of a processing machine line showing a second embodiment of the mist collecting system for multiple processing chambers. In processing machine line 2, a machine tool or the like is modularized, and such various work modules are arranged in a machine width direction. Specifically, workpiece carrying-in module 51 serving as a workpiece carrying-in section is installed at a right end of the drawing, and work modules 52, 53, 54, 55 such as a lathe or a machining center that performs process on a workpiece are installed between workpiece carrying-in module 51 and workpiece discharging module 56 serving as a workpiece carrying-out section at a left end of the drawing.

In processing machine line 2, all of work modules 51, 52, 53, 54, 55, 56 are covered by exterior covers 58 having the same shape, a conveying space extending in an entire width direction is configured in a front part of work modules 52, 53, 54, 55 and an automatic workpiece conveyor is incorporated in the conveying space. The automatic workpiece conveyor conveys workpieces taken out from workpiece carrying-in module 51 to processing chambers 61, 62, 63, 64 of work modules 52, 53, 54, 55 in this order, and retrieves workpieces processed in each of them to workpiece discharging module 56.

In processing chambers 61, 62, 63, 64, since coolant is jetted during processing to generate mist by processing heat, a mist collector is used to collect mist also in processing machine line 2. In particular, although four processing chambers 61, 62, 63, 64 are present in processing machine line 2 of the present embodiment, the mist collecting system for multiple processing chambers is implemented by single mist collector 7. Mist collector 7 is connected to a control device of processing machine line 2, and drive control according to a process program is performed.

Duct 9 is connected between mist collector 7 and processing machine line 2, and particularly branches into four processing chambers 61, 62, 63, 64. Electric duct shutters 65, 66, 67, 68 are provided in the corresponding branched ducts. Duct shutters 65, 66, 67, 68 have the same structure as the duct shutters of the embodiment shown in FIG. 3, and opening/closing of each shutter is controlled by the control device of processing machine line 2.

In the mist collecting system for multiple processing chambers of the present embodiment, in a case where workpiece processing is performed in all of work modules 52, 53, 54, 55, driving of a fan in mist collector 7 is stopped. And in a case where the workpiece processing is completed and mist collection is required in even one of them, the corresponding one of duct shutters 65, 66, 67, 68 is opened, the fan of mist collector 7 is driven, and the mist collection is started. In an example of FIG. 4, a state where the workpiece processing is executed in work modules 53 and 54 and the workpiece processing is completed in work modules 52 and 55 is shown. Therefore, while duct shutters 66 and 67 are closed, duct shutters 65 and 68 are opened, so that mist generated in processing chambers 61 and 64 is collected by mist collector 7.

Therefore, in the mist collecting system for multiple processing chambers of the present embodiment, it is possible to selectively collect mist in processing chambers 61, 62, 63, 64 by the opening/closing control on each of duct shutters 65, 66, 67, 68. It is possible to perform mist collection by single mist collector 7 for four work modules 52, 53, 54, 55, which is efficient, and it is also possible to reduce installation space of processing machine line 2.

Although one embodiment of the present disclosure has been described above, the present disclosure is not limited to this, and various modifications can be made without departing from the gist thereof.

For example, in the embodiment, although the dual-spindle lathe or the processing machine line is shown as an object that is equipped with the mist collecting system for multiple processing chambers, the present disclosure is not limited to these, and the number of processing chambers is also not limited in a range in which mist collection can be effectively performed by a mist collector.

### REFERENCE SIGNS LIST

1 . . . machine tool, 7 . . . mist collector, 8 . . . duct, 11 . . . first main spindle device, 12 . . . first turret device, 13 . . . second main spindle device, 14 . . . second turret device, 21 . . . first duct shutter, 22 . . . second duct shutter, 35 . . . first processing chamber, 36 . . . second processing chamber, 81 . . . first duct, 82 . . . second duct

1. A mist collecting system for multiple processing chambers comprising:
a mist collector configured to collect mist generated in a processing chamber;
a duct that is branched and configured to connect the mist collector to multiple processing chambers;
multiple electric duct shutters that are provided corresponding to the multiple processing chambers and are piped to branched portions of the duct; and
a control device configured to control the mist collector and opening/closing of each of the multiple duct shutters.

2. The mist collecting system for multiple processing chambers according to claim 1, wherein the duct shutter is in a closed state during workpiece processing in a corresponding processing chamber, and is switched to an opened state during mist collection after process in the processing chamber.

3. The mist collecting system for multiple processing chambers according to claim 1, wherein driving of the mist collector is stopped in a case where workpieces are under processing in all of the processing chambers.
